(19) United States
(12) Patent Application Publication
(10) Pub. No.: US 2007/0119822 A1
(43) Pub. Date: May 31, 2007

(54) Welding tongs

(76) Inventor: Stefan Schmitt-Walter, Oberhaching (DE)

Correspondence Address: YOUNG & THOMPSON, 745 SOUTH 23RD STREET, 2ND FLOOR, ARLINGTON, VA, 22202, US

(21) Appl. No.: 10/571,787

(22) PCT Filed: Jun. 2, 2004
(86) PCT No.: PCT/EP04/05935

§ 371 Date: Nov. 22, 2006

(30) Foreign Application Priority Data
Sep. 15, 2003 (DE) 203 14 294.2

(51) Int. Cl. B23K 11/31

(52) U.S. Cl. 219/86.33

(57) ABSTRACT

Welding tongs have two limbs which can be moved relative to one another. At least one first limb is supported such that it can be moved relative to a drive housing between an insertion position and a welding position. A work piece to be welded is clamped in the welding position to welding contacts on ends of the welding tong limbs, the contacts being essentially inclined towards each other. The welding tongs include a self-supporting moveable housing that can move along the drive housing and which includes a retaining device that supports the first welding tong limb outside the drive housing.

The invention relates to welding tongs with two limbs which can be moved relative to one another, of which at least one first limb is mounted such that it can be moved relative to a drive housing between an insertion position and a welding position, in which said welding position a work piece which is to be welded is clamped between welding contacts on ends of the welding tong limbs, said contacts being essentially inclined towards each other.

Such welding tongs are, for example, used along assembly lines during car production. They are used for welding panels as work-pieces, wherein the appropriate welding contacts on the opposite sides of the panels are applied generally with a predetermined force and then a welding spot or similar feature is set. In doing this, the welding tongs are moved by an appropriate handling device such that the second welding tong limb with the appropriate welding contact is brought close to the panel to be welded and then the first welding tong limb is adjusted in its welding position in which the panels are clamped between the welding contacts with the appropriate clamping force.

An appropriate clamping force may be in this connection up to a few kN or possibly even more. If the appropriate welding contacts are not exactly aligned to one another to accommodate this clamping force, transverse forces arise, which can also be in the range of a few kN, depending on the error in the alignment of the welding contacts to one another.

The transverse forces may be so large here that either the welding tong limbs, their supports or other parts of the welding tongs are damaged.

From the practice it is known that to maintain precise alignment of the welding tong limbs with respect to one another and therefore for the relatively accurate bringing together of the welding contacts, the first welding tong limb is for example supported on the second welding tong limb for displacement. This support is generally arranged outside of the drive housing between the same and the welding contacts. Although good alignment of the welding contacts with respect to one another is provided by this type of support, the free space between the welding tong limbs is restricted by the support, so that the space between the welding tong limbs can only be used in a limited way for accommodating an appropriate work-piece. Furthermore, if the spacing between the welding tong limbs is relatively large, then the support must be formed with an appropriate size.

Moreover, such a support impedes the assembly or disassembly of the welding tong limbs, because the support must also be appropriately assembled or disassembled.

The object of the invention is to improve welding tongs of the type mentioned in the introduction such that the welding tong limbs can be adjusted precisely relative to one another for contacting the work-piece with the welding contacts with relatively slight constructional effort and without restricting the free space between the welding tong limbs.

This object is solved in conjunction with the features of the generic term of Claim 1 in that the welding tongs comprise an, in particular, self-supporting movable housing, which can be displaced along the drive housing, and which comprises a retaining device that supports the first welding tong limb outside of the drive housing.

Consequently, the welding tong limbs are not brought together directly, but rather the first welding tong limb is supported by the retaining device during its displacement between its open and welding positions. The retaining device is part of a moveable housing which can be displaced along the drive housing. The retaining device can be positioned at a selectable point of the second welding tong limb with a similarly selectable alignment relative to the welding tong limb. There is the possibility that the moveable housing and thus the retaining device move to a lesser extent than the first welding tong limb, so that with sufficient support of the welding tong limb by the retaining device a relative movement between them additionally occurs.

However, to prevent such a relative movement and a corresponding support between the first welding tong limb and the retaining device, the retaining device together with the first welding tong limb can be moveable between its insertion and welding positions. The moveable housing also moves accordingly.

Various ways are conceivable of moving the moveable housing relative to the drive housing. To obtain compact welding tongs and in order at the same time to be able to transfer the forces occurring into the drive housing, the moveable housing can be moveably supported directly on the drive housing via at least one linear guide, in particular a sliding guide. Consequently, other supports or guides separate from the drive housing are not required for the moveable housing, wherein the complete construction of the welding tongs is simplified and made more compact. The support of the moveable housing can however also occur on another part of the welding tongs.

A simple embodiment of such a linear or sliding guide can be seen if the guide comprises at least one guide rail and at least one bogie which move relative to one another.

The guide rail and bogie can here each be assigned either to the drive housing or to the other part of the welding tongs or to the moveable housing. In order to particularly simplify the assignment of the guide rail and bogie during assembly, the guide rail can be fastened particularly detachably to the moveable housing and the bogie to the drive housing. The following explanations of linear and sliding guides apply analogously also to their arrangement between the other part of the welding tongs and the moveable housing.

Since the moveable housing moves relative to the drive housing, the bogie can be fixed immovably on the drive housing so that the guide rail can be displaced together with the moveable housing in the bogie.

To increase the stability between the moveable housing and the drive housing and to ensure a high accuracy in the adjustment of the first welding tong limb, at least two bogies can be arranged spaced to one another in the displacement direction of the guide rail. These bogies can in particular be positioned close to the end of the drive housing from which the first welding tong limb extends.

In order to facilitate a so-called life-time lubrication of the guide rail and bogie, the bogie can comprise a lubricant reservoir or such an item can be assigned to the bogie.

For the further stabilisation of the link between the moveable housing and the drive housing, it is possible, for example, to provide three, four or more guide rails and a corresponding number of bogies which are appropriately arranged between the housings and are in sliding contact with one another.

A simply constructed moveable housing can be obtained in that it comprises two housing halves, arranged essentially symmetrically and extending in the displacement direction, which are particularly detachably joined together at least at their ends in the displacement direction by a front and/or rear face plate. The joint between the face plates and the housing halves can for example be realised using screws or similar components. There is also the possibility that at least one of the face plates is formed in one piece with the housing halves. Through the use of such housing halves different thermal expansions of the drive housing and the moveable housing can be more easily compensated.

Due to the essentially symmetrical arrangement of the housing halves, they can comprise the same construction so that overall the manufacture of the housing halves is simplified. In addition, the housing halves can be interchanged or combined with one another as required.

In order to cover the drive housing to a larger extent by the moveable housing, the housing halves can be formed approximately C-shaped and a cover panel can be positioned between two facing top ends of the housing halves. Through the assembly of the housing halves using the face plates and by arranging the cover panel, an essentially similarly C-shaped moveable housing is produced which at least partially encloses the drive housing. There is similarly the possibility of using a one-part, essentially C- or U-shaped moveable housing.

It may be convenient to provide two guide rails on each housing half, wherein an appropriate number of bogies are arranged externally on the drive housing.

For the simplified arrangement of the cover panel it is sufficient if insertion grooves for the circumferential retention of the cover panel are formed in the upper ends of the housing halves and facing inner sides of the face plates. The cover panel is then simply inserted with its corresponding edge into the insertion grooves and is reliably held there after the fixing of the housing halves by means of the face plates.

In order to be able to align the guide rails for the precise guidance of the first welding tong limb between the insertion and welding positions, each housing half can comprise two rail indentations on its inner side in the displacement direction at least for the insertion of the appropriate guide rails from a lower end.

There is also the possibility that the guide rails are formed in on piece with the housing halves.

Different methods of fastening the guide rails in the rail indentations are conceivable. The guide rails could for example be inserted into the rail indentation and then be welded. Constructively more simple and better suited to the interchange of the guide rails is however an embodiment in which the guide rails are detachably mounted in the associated rail indentation and in particular using screws. An appropriate screwed joint can be realised from the outer side of the associated housing half or from the moveable housing, so that the guide rails are drawn into the rail indentations on tightening the screws.

In order to retain the guide rails in the corresponding rail indentations not just non-positively, but also with positive locking, a fixing slot can extend in the height direction of the guide rail in the housing half which extends along the rail indentations and opens out into it or is arranged adjacent to it. In order to fix the guide rail with positive locking into the rail indentation through elastic deformation of the housing half by means of the fixing slot, a number of clamping holes running transverse to the fixing slot are formed in each housing half for screwing in suitable clamping screws. When the corresponding clamping screws are screwed into the clamping holes, the fixing slot is pressed together by the elastic deformation of the housing half and thus the rail indentation is constricted transversely to the guide rail and for the positively locked retention of the guide rail.

There is a further possibility for the supplementary positively locked retention of the guide rails in that the rail indentation comprises two indentation sections formed with different depths and adjacent to one another, wherein the lower end of the guide rail is arranged in the first indentation section with smaller depth and in the second indentation section with a greater depth a pressure pad is arranged, which in particular detachably fixes the guide rail within the rail indentation relative to a rail reference edge. This means that through the pressure pad a rail indentation essentially variable to a certain extent in its width is formed, wherein the guide rail is fixed by the rail reference edge at one side and by the pressure pad at the other side.

There is the possibility that the rail reference edge is formed by a step edge between the two indentation sections and/or by an edge of the rail indentation opposite the pressure pad relative to the guide rail.

In order to be able to arrange the pressure pad in a simple manner in the second indentation section, the pressure pad can be mounted detachably within the second indentation section and can be applied with a force in the direction towards the rail reference edge.

With a simple embodiment the force application of the pressure pad can be implemented by screws arranged at the side and in particular by set screws.

The guidance of the moveable housing relative to the drive housing can be refined in its accuracy if, for example, the bogies can be pressed against a bogie reference edge formed on the drive housing and extending in the displacement direction.

The pressure can be applied analogous to the guide rail in that for example screws and, in particular, set screws are provided.

According to the invention there is the possibility of using a drive device within the drive housing, such as for example disclosed in DE 20 201 734 from the same applicant. This type of drive device comprises as a mechanical adjustment device in the displacement direction a screw drive with threaded rod and screw drive nut. The screw drive nut can be rotated, but is fixed axially and the threaded rod is fixed rotationally, but can move axially. In order to displace the front face wall of the moveable housing, which is formed as the retaining device, in a simple manner by means of the threaded rod for adjusting the first welding tong limb between the insertion and welding positions, the threaded rod can engage, particularly rotationally fixed, with its extension end in an indentation formed on the inner side of the front face plate where it is detachably fastened to the front face plate.

A direct connection between the first welding tong limb and for example the threaded rod is not required in this respect; instead the first welding tong limb can be fastened, particularly detachably, to the outer side of the front face plate positioned opposite the inner side.

In order to prevent the ingress of dirt or similar contamination between the drive housing and the moveable housing also in the region of the lower ends of the housing halves, cover panels can protrude at the lower ends of the housing halves in the direction of the drive housing.

If the welding tongs are moved within the space by an appropriate handling device, then they can be arranged in positions in which after the appropriate drive device is switched off the first welding tong limb and similarly the moveable housing move automatically due to the acting force of gravity. To prevent this for reasons of accident prevention, the drive device can comprise a, particularly magnetically operating, brake device which inhibits the rotation of the screw drive nut and extension of the threaded rod on switching off the drive device.

In order to keep friction between the guide rail and bogie as low as possible, the bogie can comprise surrounding rolling elements such as balls or similar components to reduce the friction. Then in a known manner, the guide rail moves along these rolling bodies when the moveable housing moves.

In order to design the moveable housing as short as possible in the displacement direction, the rear face plate can be of an essentially inverse U-shape and partially grip the drive housing with its U-opening. In this way it is not necessary that the moveable housing is formed with a so great a length in the displacement direction which ensures that the drive housing is always at least partially surrounded by the moveable housing independently of the movement of the same.

In order to facilitate in a simple manner a suitable supply, in particular of the drive device and its controller, depending on the arrangement of the welding tongs and the available space outside of the welding tongs, the drive housing can at an end facing away from the first welding tong limb comprise a detachable rear housing section with electrical leads and/or a control electronics unit and/or a tachometer generator or similar item, the said rear housing section being able to be arranged and mounted in different rotational positions relative to the rest of the drive housing. Due to the different rotational positions particularly the electrical cables can be brought to the welding tongs from different sides.

In order to be able to mount the drive housing in a simple and secure manner, the drive housing can comprise mounting flanges protruding at the side for the detachable mounting on a base plate. The detachable mounting can occur through appropriate screws or similar components. This base plate can be the other part of the welding tongs, between which and the moveable housing the linear/sliding guide(s) is (are) provided—refer to the above descriptions.

The base plate can be part of the welding tongs with which the same is mounted for example on a handling device or similar item. The base plate can similarly be part of the handling device.

If the base plate is part of the welding tongs, it can be directly or indirectly connected to an appropriate handling device.

With an indirect connection to the handling device a tongs compensating device can be arranged between the same and the base plate. Such a tongs compensating device is used for example for the spatial alignment of the welding tongs or at least of the second welding tong limb.

In order to facilitate an appropriate alignment, the tongs compensating device can comprise an adjustment device for the second welding tong limb and/or the drive housing or the base plate.

With a simple embodiment the adjustment device can comprise a displacement device between particularly the base plate and a base frame, which can be joined to the handling device, and an associated drive device. The drive device can be constructed within the drive housing analogously to the drive device.

Similarly, analogously to the sliding guides between the moveable housing and the drive housing, the displacement device of the adjustment device can also comprise at least two guide rails and bogies assigned to them.

In this connection it might be considered advantageous if the guide rails are detachably fixed to the base frame and the bogies are moveable along the guide rails, wherein the same are fixed detachably to the base plate. This means that the arrangement of the fixed and moveable parts is inverse of the arrangement between the moveable housing and the drive housing.

As already mentioned above, it may be regarded as convenient if at least two bogies are in each case assigned to each guide rail.

The bogies and guide rails can, as already explained above, be mounted non-positively on the appropriate parts, wherein it may furthermore be considered convenient if the bogies and/or guide rails are mounted on the base plate or base frame relative to reference edges so that, as also explained above, positively locked mounting is additionally produced.

In order to be able to simply mount the second welding tong limb in this connection, the same can be detachably mounted at its mounting end on an underside of the base plate facing away relative to the drive housing. Consequently, the second welding tong limb can also be simply mounted or removed.

To obtain overall welding tongs with a small size, which are formed extremely compactly, the drive housing with the mounted moveable housing, base plate, tongs compensating device and base frame can be arranged essentially one above the other and exhibit essentially the same dimensions in the displacement direction and/or in the direction transverse to the displacement direction. Consequently, no part of the welding tongs protrudes from the drive housing or the base plate, wherein the arrangement of the welding tongs is simplified in a limited space and at the same time possible injuries due to such protruding parts of the welding tongs are prevented.

In order to prevent the ingress of dirt or similar contamination during the movement of the moveable housing for adjustment of the first welding tong limb between the insertion and welding positions, a bellows of the drive device can be detachably mounted with an end on the inside of the front face plate and with its other end particularly on a shoulder within the drive housing. Here, the bellows encloses the screw drive nut and the extended threaded rod.

In order to be able to accommodate and divert the forces introduced into the welding tongs via the self-supporting moveable housing, a positive locking joint, particularly using locating pins, feather keys, films with hard particles or similar items, can be formed between the face plates and the housing halves and/or the base plate and the drive housing or the moveable housing. The locating pins and feather keys would in this connection extend between the face plates and the housing halves or the drive/moveable housing, respectively its mounting flange and the base plate. The film with hard particles can be formed as a thin film with hard particles of diamond, corundum or similar material arranged on both sides. On mounting the appropriate parts, for example face plates and housing halves, the hard particles are pressed into the respective surfaces of the parts where they grip by establishing positive locking.

In the following, an advantageous embodiment of the invention is explained in more detail based on the figures enclosed in the drawing.

The following are shown:

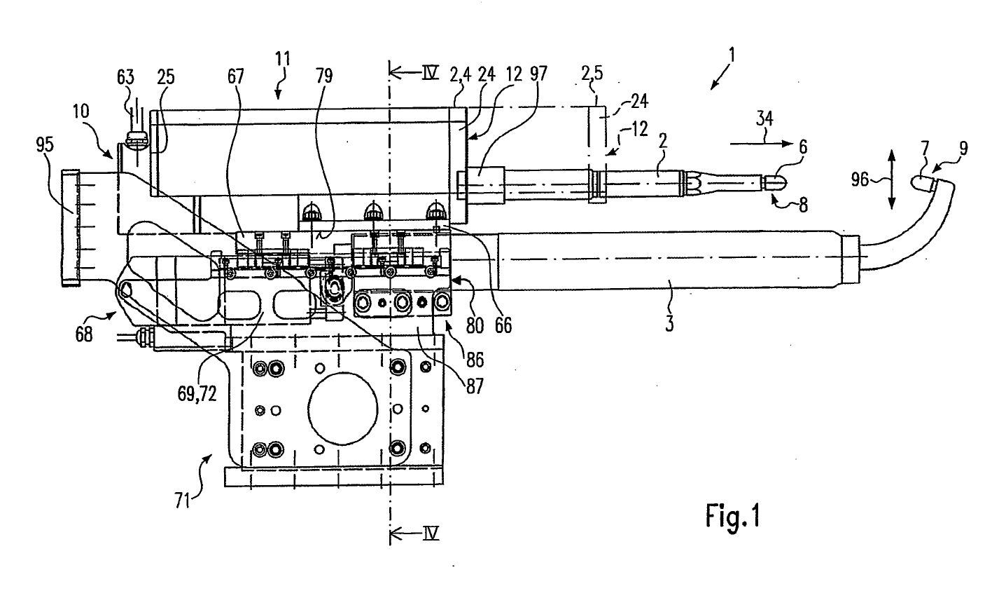

FIG. 1 a side view of an embodiment of the welding tongs according to the invention;

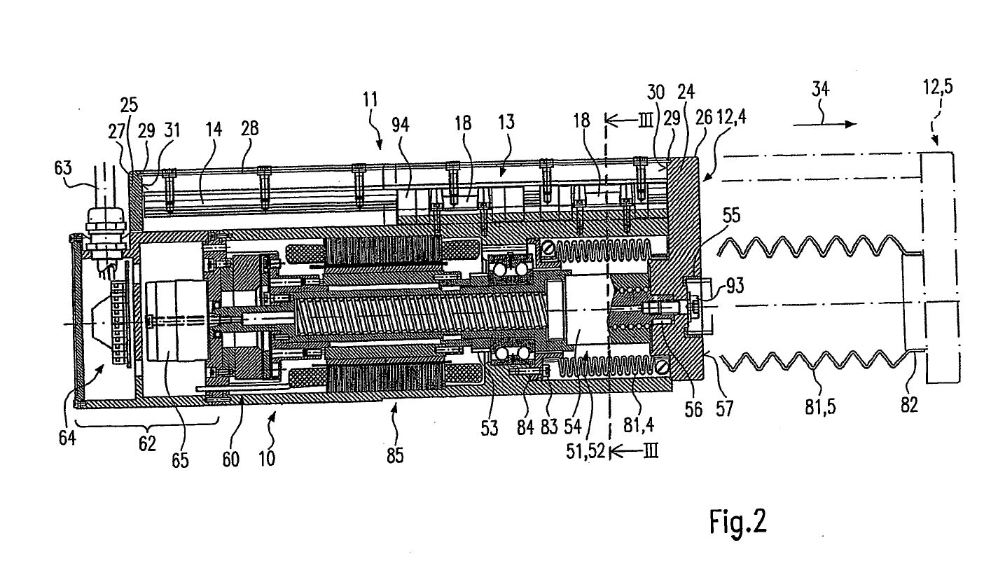

FIG. 2 a longitudinal section through the welding tongs according to FIG. 1;

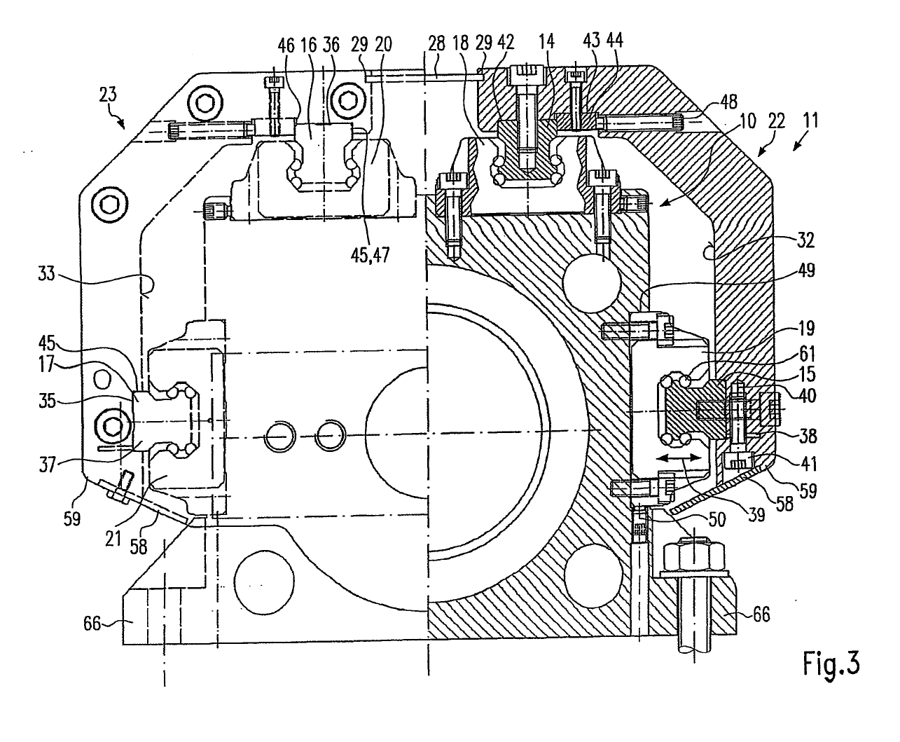

FIG. 3 a section along the line III-III from FIG. 2;

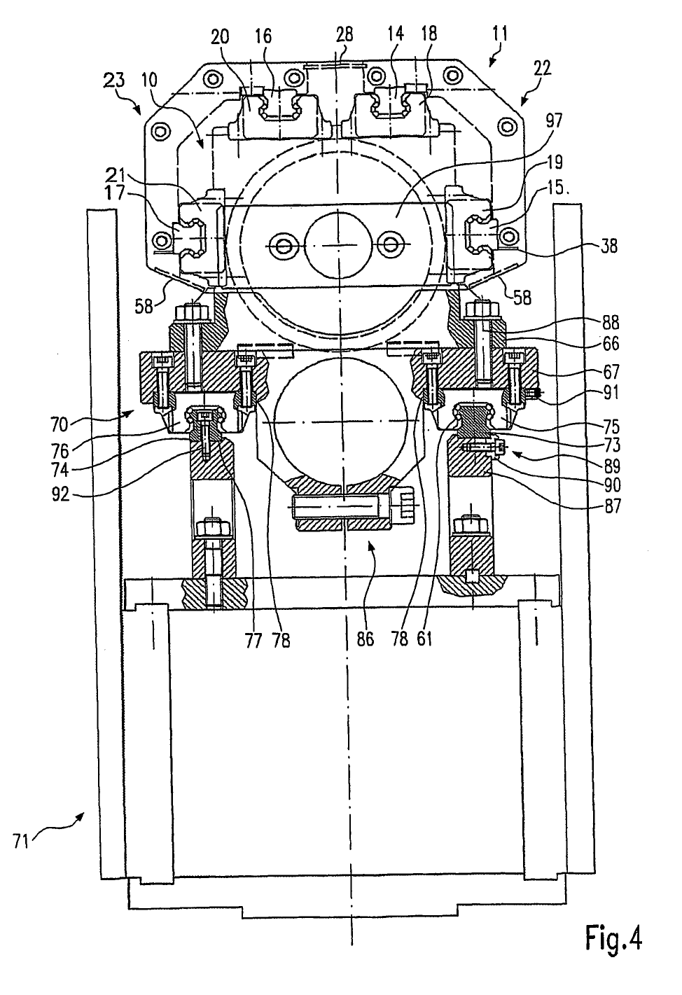

FIG. 4 shows a section along the line IV-IV from FIG. 1, and

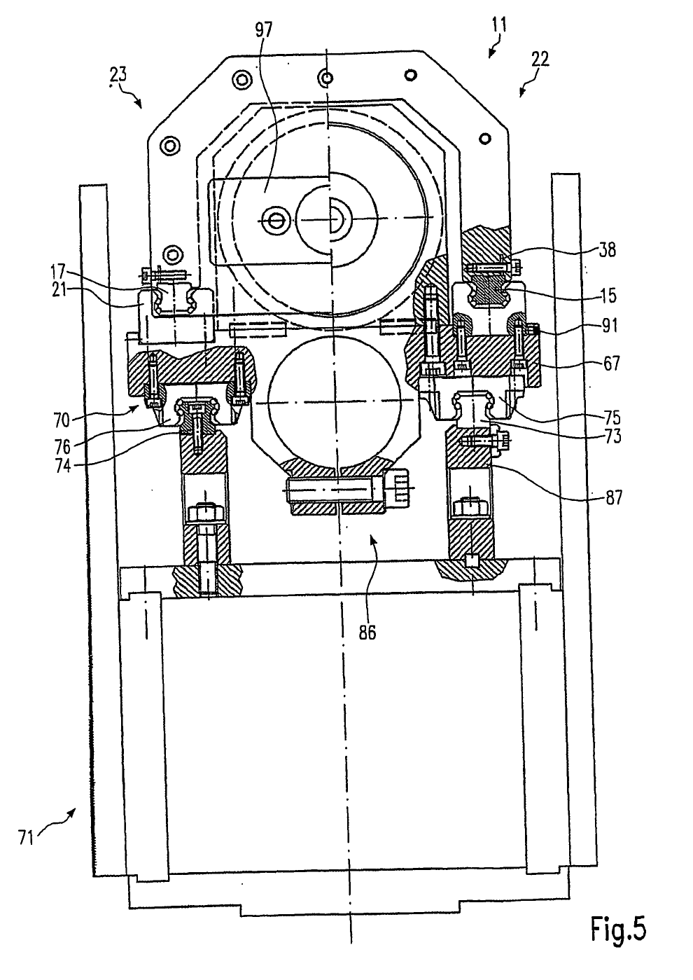

FIG. 5 a section analogous to FIG. 4 through a further embodiment.

In the side view according to FIG. 1 an embodiment of some welding tongs 1 with a first welding tong limb 2 and a second welding tong limb 3 is illustrated. Such welding tongs are generally designated as C-welding tongs due to the arrangement of the welding tong limbs.

Using a drive device 85, refer also to FIG. 2, the first welding tong limb 2 is moveable in the displacement direction 34 between an insertion position 4 and a welding position 5. The welding position 5 is shown in broken lines in FIG. 1, wherein reproduction of the first welding tong limb 2 for this position has been omitted for clarity.

At the ends 8 and 9 of the welding tong limbs 2 and 3 welding contacts 6 and 7 are fitted which essentially face one another. In the welding position 5 of the first welding tong limb 2 the welding contacts 6 and 7 have come so close that work-pieces located between them, such as for example panels or similar materials, are pressed together and can be welded together by setting a welding spot.

To prevent transverse forces on the welding tong limbs 2 and 3 in the welding position 5 in a vertical plane defined by the deflection directions 96, on one hand the first welding tong limb 2 is pushed so precisely into the welding position 5 such that the corresponding welding contacts 6 and 7 meet without larger transverse forces in the deflection directions 96. The remaining transverse forces are on the other hand accommodated by a moveable housing 11 of a self-supporting design and via its connection to the drive housing 10 or to a base plate 67 introduced into a handling device or similar device in or via the moveable housing.

The first welding tong limb 2 is held by a retaining device 12, wherein it is detachably mounted on it by its mounting end 97. The retaining device 12 is part of the moveable housing 11 and in particular its front face plate 24. The retaining device 12 is pushed together with the moveable housing 11 and with the first welding tong limb 2 between its insertion position 4 and the welding position 5.

The moveable housing 11 grips at least partially a drive housing 10 which contains the drive device 85. The moveable housing 11 is formed self-supporting and is held for sliding displacement in the displacement direction 34 on the drive housing 10.

The drive housing 10 is mounted detachably at a lower end on the base plate 67 by means of a mounting flange 66 protruding at the side. A tongs compensating device 68 is arranged below this base plate 67. This is used for the adjustment of the second welding tong limb 3. The tongs compensating device 68 comprises at least one adjustment device 69 for the second welding tong limb as well as an appropriate drive device 72. The drive device 72 is constructed analogously to the drive device 85.

The base plate 67 is joined detachably and for sliding movement at its underside 79, refer also to FIG. 4, to beams 87 as part of a base frame 71. The sliding displacement occurs appropriately by actuating the tongs compensating device 68. The base frame 71, refer also to FIG. 4, furthermore comprises a joining flange 95, which is used for mounting the base frame 71 and thus the welding tongs 1 on a handling device which is not illustrated.

With regard to the second welding tong limb 3 it should be noted that it is detachably mounted at its mounting end 80 in an appropriate welding tong limb support 86 on the underside of the base plate 67.

FIG. 2 illustrates a longitudinal section through the welding tongs 1 according to FIG. 1.

The moveable housing 11 is placed onto the drive housing 10, wherein a series of sliding guides 13 with many guide rails 14 to 17 and bogies 18 to 21 are formed between both of them, refer also to FIG. 3 in this respect. A guide rail 14 with a pair of bogies 18 can be seen in the illustration according to FIG. 1. The guide rail 14 is fastened by screws to the inner side of the moveable housing 11. The bogies 18 are mounted in the displacement direction 34 on an outer side of the drive housing 10 using screws. Here, the two bogies 18 are arranged in a front half of the drive housing 10 facing the front face plate 24 of the moveable housing 11. Each of the bogies 18 as well as 19 to 21 can comprise a lubricant reservoir 94 for life-time lubrication.

The moveable housing 11 comprises the front face plate 24, respectively a rear face plate 25 at its ends lying in the displacement direction 34. These are detachably joined to the moveable housing 11 using screws. As already explained, the front face plate 24 forms the retaining device 12 for the first welding tong limb 2, wherein this face plate can also be moved appropriately in the displacement direction 34 between the insertion position 4 and the welding position 5 of the first welding tong limb 2. Insertion grooves 29, in which an appropriate edge of a cover panel 28 is inserted, refer also to FIG. 3, are formed on the inner sides 30, 31 of the face plates 24, 25 at their upper ends 26, 27.

The rear face plate 25 is essentially inverse U-shaped so that it, refer also to FIG. 1, partially grips around the drive housing 10 from above. The front face plate 24 covers essentially a front end of the drive housing 10. Within the drive housing 10 the drive device 85 is arranged which at least comprises a screw drive 52 as the mechanical adjustment device 51. The screw drive 52 comprises a threaded rod 53 and a screw drive nut 54. The threaded rod 53 is supported rotationally fixed, but moveable axially in the displacement direction 34, whereas the screw drive nut 54 can rotate, but is supported without axial movement. The rotation of the screw drive nut 54 occurs by means of an electromagnetic motor of the drive device 85. The appropriate drive device is described in detail in DE 202 01 734.

The threaded rod 53 is inserted, in particular rotationally fixed, with its extending end 55 facing the first welding tong limb 2 in an indentation 56 formed on the inner side 30 of the front face plate 24 where it is fastened by means of a mounting screw 93 screwed through the face plate 24. The mounting end 97 of the first welding tong limb 2, refer also to FIG. 1, is detachably fastened, for example by screwing, to an outer side 57 of the front face plate 24.

In FIG. 2 the front face plate 24 is shown in broken lines in the appropriate welding position 5, refer also to FIG. 1, wherein a bellows 81 is arranged between this position and a shoulder 84 formed in the drive housing 10. The bellows 81 is detachably fastened at its front end 82 to the inner side 30 of the front face plate 24 and at its rear end 83 to the shoulder 84. Thus, the bellows 81 encloses both the screw drive nut 54 as well as the extended threaded rod 53. In the appropriate welding position 5 the bellows is extended, refer to the appropriate labelled position of the bellows 81 according to FIG. 2.

The drive device 85 furthermore comprises a brake device 60 which is formed as a magnetic brake with electromagnets and permanent magnets. If the electrical supply to the brake device 60 is interrupted, the permanent magnet is held rotationally fixed by the appropriate magnetic forces so that no rotation of the screw drive nut 54, and thus no extension of the threaded rod 53, is possible. With the electrical supply present the magnetic force of the permanent magnet is compensated by the electromagnet so that a rotation of the screw drive nut 54 is possible.

The drive housing 10 comprises a rear housing section 62 on its rear side facing away from the front face plate 24. This rear housing section can be fixed to the rest of the drive housing 10 in various rotational positions with respect to it. A control electronics unit 64 and a tachometer generator 65 for example are arranged within the rear housing section 62. In addition, the electrical cables 63 are arranged on the rear housing section 62.

In FIG. 3 a section along the line III-III from FIG. 2 is illustrated, wherein some details have been omitted for simplification, particularly within the drive housing 10. In this figure as in all other figures, the same reference symbols label the same parts.

In the section according to FIG. 3 the division of the moveable housing 11 with housing halves 22 and 23 can in particular be recognised. These housing halves 22 and 23 are joined detachably to the face plates 24 and 25 at their ends lying in the displacement direction 34, refer to the left half in FIG. 3. On the inner sides 32, 33 of the housing halves 22, 23 the guide rails 14, 15 and correspondingly 16, 17 are arranged essentially on the upper and lower ends of the said housing halves. The construction of the housing halves 22, 23 with appropriate devices is of the same type so that the description of the construction of housing half 22 is sufficient.

In the region of the guide rails 14 to 17 appropriate rail indentations 35, 36 are arranged in which at least the lower ends 37 of the guide rails 14 to 17 are inserted. The detachable mounting of the guide rails in the rail indentations 35, 36 occurs using screws. Apart from the non-positive mounting by the screws, a positively locked mounting also occurs for the accurate alignment of the guide rails 14 to 17.

A fixing slot 38 is provided with the rail indentation 35 in a first embodiment of such a positively locked attachment. This runs in the height direction 39 of the guide rails 15, 17 within the appropriate housing half and opens out into the corresponding rail indentation 35. Clamping holes 40, in which clamping screws 41 can be screwed, extend within the housing halves 22, 23 transversely to the fixing slot 38. By appropriately screwing the clamping screws 41 in the clamping holes 40, a corresponding lower end 59 of the housing halves 22, 23 can be elastically deformed by means of the fixing slot 38 so far in the direction of the guide rails 15, 17 that the guide rails are pressed firmly onto an appropriate rail reference edge 45.

With a further embodiment of such a positive locking arrangement, refer to the rail indentations 36, the rail indentations comprise a first indentation section 42 and a second indentation section 43 with different depths. The appropriate lower end 37 of guide rails 14, 16 is arranged in the first indentation section 42 with a shallower depth. A pressure pad 44 extending along the appropriate guide rails is inserted in the second indentation section 43 with a greater depth. The pressure pad is appropriately detachably fastened in the rail indentation 36 by screwing. For applying sideward force to the pressure pad 44, screws and in particular set screws 48 are provided which press the pressure pad 44 in the direction of the lower end 37 of the associated guide rails 14, 16 and thus press the guide rails onto an appropriate edge 47 of the rail indentation 36 as the rail reference edge 45. The step edge 46 formed between the different indentation sections 42, 43 is in the illustrated embodiment not a rail reference edge 45, but rather is arranged with a slight spacing to the pressure pad 44 in the reference position with the arrangement of the guide rails 14, 16.

Rolling elements 61 for the reduction of friction and which circulate in the bogies 18, 21 are arranged between the appropriate guide rails 14, 17 and the associated bogies 18, 21. The bogies 18 to 21 are detachably mounted on the outer side of the drive housing 10, in particular using screwed joints. Apart from the non-positive locking arrangement, the bogies 18 to 21 are also arranged positively locked, wherein they are pressed by screws, in particular set screws 50, against associated bogie reference edges 49. Appropriate screws are provided for all bogies 18, 21, wherein it is again pointed out that for each of the guide rails 14, 17 in the illustrated embodiment a pair of bogies is provided in each case.

At the lower ends 59 of the housing halves 22, 23 protruding cover panels 58 are arranged diagonally downwards and in the direction of the drive housing 10. They prevent the ingress of dirt into the free space between the drive housing 10 and the moveable housing 11.

The housing halves 22, 23 are formed approximately C-shaped, wherein the cover panel 28 is positioned between the upper facing ends of the housing halves 22. The said cover panel is inserted with its appropriate edges into insertion grooves 29 formed there, refer also to FIG. 2.

In FIG. 4 a section along the line IV-IV from FIG. 1 is illustrated, wherein some details have been omitted for simplification, particularly in the region of the moveable housing 11 and drive housing 10.

With regard to the description of the latter, reference is made to FIGS. 3 and 2.

The drive housing 10 comprises at its lower end the mounting flanges 66 which protrude outwards. They are used both for sitting on the base plate 67 and for the detachable mounting on the same using threaded studs 88. On its underside the base plate 67 comprises in each case two bogies 75, 76 which are detachably mounted by means of appropriate screws. For the alignment of the bogie pairs 75, 76, appropriate reference edges 78 are provided against which the bogies 75, 76 can be pressed by means of screws, in particular set screws 91. The base plate 67 can be moved along the base frame 71 via these bogies 75, 76 by means of the adjustment device 69 with appropriate drive device 72, refer also to FIG. 1. The base frame 71 here comprises beams 87 on the upper side of which appropriate guide rails 73, 74 are arranged, along which the bogies 75, 76 can be moved. The guide rails 73, 74 are detachably arranged by appropriate screws 92 and are also pressed against associated reference edges 77. In this connection a screw 89 with dummy block 90 provides the pressure, wherein the dummy block is pressed on a lower end of the guide rails 73, 74 opposite the corresponding reference edge 77 by screwing in the screw 89.

Similarly, the welding tongs support 86 for the mounting end 80 of the second welding tong limb 3 is arranged on the underside of the base plate 67.

Not illustrated for the sake of clarity are the locating pins, feather keys, a film with hard particles or similar materials which are arranged between the face plates 24, 25 and the housing halves 22, 23 and/or between the base plate 67 and the drive housing 10 or the mounting flanges 66 respectively. These are used for the positively locked joining of these parts. The appropriate film comprises on both its sides hard particles of corundum, diamond or similar material, which on fastening the appropriate parts together press into them and grip them.

In FIG. 5 a section analogous to FIG. 4 through a further embodiment is shown. For simplification only the appropriate differences to the embodiment according to FIG. 4 are pointed out, wherein the same parts are labelled by the same reference symbols.

With the embodiment according to FIG. 5 the moveable housing 11 is formed from one piece and supported directly on the base plate 67 via two guide rails 15, 17 and corresponding bogies 19, 21. Consequently, the corresponding sliding guides are no longer arranged between the moveable housing 11 and the drive housing 10, but rather between the moveable housing 11 and the base plate 67. A direct connection between the housings 10 and 11 is no longer present. In the embodiment according to FIG. 5 there is the possibility of providing more than two guiding carriages 19, 21 for each of the guide rails 14, 17.

The alignment of the guide rails and guiding carriages occurs analogous to the preceding embodiments, wherein appropriate set screws 91 and fixing slots 38 with appropriate clamping holes and clamping screws are provided.

The connection between the base plate 67 and the remaining parts of the welding tongs 1 occurs similarly analogously to the preceding embodiments, refer to the other sliding guides between the base plate 67 and base frame 71.

In FIG. 5 the front and rear face plates can be arranged analogously to the preceding embodiment, wherein also here a film with diamonds, corundum or other hard particles can be arranged between the corresponding metal surfaces. This film with hard particles protruding from it on both sides is used for the positively locked anchoring of the parts to be joined together, wherein the hard particles engage in the corresponding, mutually facing surfaces of the parts—here in the surfaces of the face plates and surfaces of the ends of the remaining moveable housing 11. Instead of a film a mesh-type thin material can be used in which the hard particles are embedded such that they protrude on both sides and/or are arranged on both sides of the thin material. It is obvious that such a film with the hard particles can be used independently of the welding tongs for the positively locked joining of facing surfaces of appropriate work-pieces, in particular in connection with a non-positive joint by means of screws or similar components. Here, it is not necessary that the surfaces are plane parallel, but rather stepped surfaces, corrugated surfaces and other structured surfaces can be joined positively locked appropriately to complementarily formed surfaces of a work-piece to be joined with such intervening films. Similarly, there is the possibility that the film for mounting on a surface of a work-piece can be glued or also the hard particles are directly applied with uniform thickness onto a surface of the appropriate work-piece or similar article or directly applied, for example, by adhesive.

1. Welding tongs with two limbs which can be moved relative to one another, of which at least one first limb is supported such that it can be moved relative to a drive housing between an insertion position and a welding position, a work piece to be welded being clamped in said welding position to welding contacts on ends of the welding tong limbs, said contacts being essentially inclined towards each other, wherein the welding tongs comprise a particularly self-supporting moveable housing, which can move along the drive housing and which comprises a retaining device which supports the first welding tong limb outside the drive housing.

2. Welding tongs according to claim 1, wherein the retaining device can be moved together with the first welding tong limb between said insertion and welding positions.

3. Welding tongs according to claim 1, wherein the moveable housing is supported for movement on the drive housing and/or on another part of the welding tongs by at least one linear guide, in particular a sliding guide.

4. Welding tongs according to claim 3, wherein the sliding guide comprises a guide rail and at least one bogie, which are moveable relative to one another.

5. Welding tongs according to claim 4, wherein the guide rail on the moveable housing and the bogie on the drive housing are each particularly detachably mounted.

6. Welding tongs according to claim 5, wherein the bogie is fixed immovably on the drive housing.

7. Welding tongs according to claim 6, wherein at least two bogies are arranged spaced from one another in the displacement direction of the guide rail.

8. Welding tongs according to claim 7, wherein the bogie comprises a lubricant reservoir.

9. Welding tongs according to claim 8, wherein the moveable housing comprises two housing halves, arranged essentially symmetrically to one another and extending in the displacement direction and which are detachably joined together at least at their ends by a front and/or rear face plate, wherein the front face plate is formed as a retaining device.

10. Welding tongs according to claim 9, wherein the housing halves are formed in an approximate C-shape, and a cover panel is arranged between two mutually facing upper ends of the housing halves.

11. Welding tongs according to claim 10, wherein insertion grooves for the circumferential retention of the cover panel are formed in the upper ends of the housing halves and in mutually facing inner sides of the face plates.

12. Welding tongs according to claim 11, wherein each housing half comprises on its inner side two rail indentations running in the displacement direction at least for the insertion of the lower ends of the corresponding guide rails.

13. Welding tongs according to claim 12, wherein the guide rails are detachably mounted in the associated rail indentation, in particular by screwed joints.

14. Welding tongs according to claim 13, wherein a fixing slot formed in the height direction of the guide rail in the housing halves runs along the rail indentation and opens out into the same or is arranged adjacent to the same and a number of clamping holes running transversely to the fixing slot are formed in the housing halves for screwing in appropriate clamping screws.

15. Welding tongs according to claim 14, wherein the rail indentation formed with a different depth comprises indentation sections adjacent to one another, wherein the first indentation section with a shallower depth accommodates the lower end of the guide rail and a pressure pad is arranged in the second indentation section with a greater depth, which in particular detachably fixes the guide rail within the rail indentation relative to a rail reference edge.

16. Welding tongs according to one of the aforementioned claims claim 15, wherein the rail reference edge is formed by a step edge between the two indentation sections and/or by an edge of the rail indentation lying opposite the pressure pad relative to the guide rail.

17. Welding tongs according to claim 16, wherein the pressure pad is mounted detachably within the second indentation section and for force application in particularly sideward in the direction of the rail reference edge.

18. Welding tongs according to claim 17, wherein screws and in particular set screws are provided for the sideward application of force to the pressure pad.

19. Welding tongs according to claim 18, wherein the bogie can be pressed on a bogie reference edge formed outside on the drive housing and extending in the displacement direction.

20. Welding tongs according to claim 19, wherein screws and in particular set screws are provided for pressing on the bogie reference edge.

21. Welding tongs according to claim 20, wherein a drive device within the drive housing comprises a screw drive with threaded rod and screw drive nut as a mechanical adjusting device in the displacement direction, wherein the screw drive nut is arranged rotatable, but axially fixed and the threaded rod rotationally fixed, but axially moveable, the said threaded rod engaging, particularly rotationally fixed, with its extended end in an indentation formed on the inner side of the front face plate and being mounted detachably on the front face plate.

22. Welding tongs according to claim 21, wherein the first welding tong limb is particularly detachably mounted on the outer side of the front face plate opposite the inner side.

23. Welding tongs according to claim 22, wherein the cover panels on the lower ends of the housing halves, protrude in the direction of the drive housing.

24. Welding tongs according to claim 23, wherein the drive device comprises a particularly magnetically operating brake device.

25. Welding tongs according to claim 24, wherein the bogie comprises circulating rolling elements for reducing friction.

26. Welding tongs according to claim 25, wherein the rear face plate is essentially inverse U-shaped and partially grips around the drive housing with its U-opening.

27. Welding tongs according to claim 26, wherein the drive housing comprises a detachable rear housing section lying opposite the first welding tong limb with electrical cables and/or a control electronics unit and/or a tachometer generator or similar device, the said rear housing section being in particular arrangeable and mountable in different rotational positions relative to the remaining drive housing.

28. Welding tongs according to claim 27, wherein the drive housing comprises a sideward protruding mounting flange for the detachable mounting of a base plate.

29. Welding tongs according to claim 28, wherein the base plate can be directly or indirectly connected to a handling device.

30. Welding tongs according to claim 29, wherein with an indirect connection to the handling device a tongs compensating device is arranged between the said handling device and the base plate.

31. Welding tongs according to claim 30, wherein the tongs compensating device comprises an adjustment device for the second welding tong limb and/or the drive housing.

32. Welding tongs according to claim 31, wherein the adjustment device comprises a displacement device between particularly the base plate and a base frame, which can be connected to the handling device and a drive device.

33. Welding tongs according to claim 32, wherein the displacement device comprises at least two guide rails and bogies assigned to them.

34. Welding tongs according to claim 33, wherein the guide rails are detachably fixed to the base frame and the bogies can be moved along the guide rails, wherein they are detachably fixed to the base plate.

35. Welding tongs according to claim 34, wherein at least two bogies are assigned to each guide rail.

36. Welding tongs according to claim 35, wherein the bogies and/or the guide rails are mounted on the base plate or respectively on the base frame relative to the reference edges.

37. Welding tongs according to claim 36, wherein the second welding tong limb is detachably mounted at its mounting end on an underside of the base plate facing away from the drive housing.

38. Welding tongs according to claim 37, wherein the drive housing with the moveable housing in place, the base plate, the tongs compensating device and the base frame are arranged essentially one above the other and exhibit essentially the same dimensions in the displacement direction and/or in the direction transverse to the displacement direction.

39. Welding tongs according to claim 38, wherein a bellows of the drive device is detachably mounted with one end on the inner side of the front face plate and its other end particularly on a shoulder within the drive housing.

40. Welding tongs according to claim 39, wherein a positively locked joint is formed between the face plates and the housing halves and/or between the base plate and drive housing or moveable housing, in particular by locating pins, feather keys, film with hard particles or similar components.
